(19) United States
(12) Patent Application Publication
(10) Pub. No.: US 2005/0037932 A1
(43) Pub. Date: Feb. 17, 2005

(54) Ultra-thin lubricant film for advanced tribological performance of magnetic storage media

(76) Inventors: Jianwei Liu, Fremont, CA (US); Michael Joseph Stirniman, Fremont, CA (US); Jing Gui, Fremont, CA (US); Xinwei Li, San Jose, CA (US)

Correspondence Address: MOSER, PATTERSON & SHERIDAN, L.L.P., Suite 1500, 3040 Post Oak Boulevard, Houston, TX, 77056, US

(21) Appl. No.: 10/641,599

(22) Filed: Aug. 15, 2003

(51) Int. Cl. C10M 101/00; B05D 5/12; C08F 2/48

(52) U.S. Cl. 508/458; 427/129; 427/496; 427/508; 428/694 BP; 428/694 BF; 508/582; 508/590; 508/577

(57) ABSTRACT

A perfluoropolyether lubricant topcoat having at least one end-group having an epoxide ring is applied to a magnetic recording medium. Post-lubing treatment, such as ultraviolet (UV) light irradiation, of the perfluoropolyether lubricant topcoat initiates chemical bonding between the epoxide end-group and the medium surface. The lubricant of the present invention provides improved tribological performance over conventional lubricants.

### BACKGROUND OF THE INVENTION

1. Field of the Invention

Embodiments of the present invention generally relate to lubricants. More particularly, embodiments relate to lubricants used in thin-film magnetic storage media for improving the reliability and durability of the media.

2. Description of the Related Art

Information storage systems, such as disk drives found in personal computers and other data processing devices, employ a thin-film magnetic storage medium, such as a disc, which is moved relative to a read/write head to provide information introduction and/or retrieval from the magnetic storage medium. In accordance with conventional practices, the surface of the disc is lubricated with a thin film of lubricant to reduce friction and wear of the media due to head-disc contact during drive operation, and particularly during start and stop cycles that correspond to the turning on and off of a computer.

While the computer is turned off, the head typically rests on the surface of the disc. During the start-up of a disk drive, the disc starts to rotate and the read/write head begins to slide against the surface of the disc. As the disc continues to spin up, the distance between the head and the disc increases as the head takes off and begins to fly above the surface of the disc. Upon reaching a predetermined rotational speed, the head flies at a predetermined distance from the surface of the disc where the head is maintained during reading and writing operations. The very close proximity of the head to the disc can cause further wear of the media. Upon terminating operation of the disk drive, the disc spins down and the fly height of the head decreases until the head begins to slide against the surface of the disc and come to a stop. During drive operation, head-disc contacts may lead to excessive wear of the protective overcoat and catastrophic drive failure.

The thin-film magnetic storage medium typically comprises a thin rigid Al alloy substrate, successively sputtered layers, and a topical lubricant layer. The sputtered layers can include an underlayer, a magnetic layer, and a protective overcoat. The protective overcoat is typically a carbon overcoat which protects the magnetic layer from corrosion and oxidation and reduces frictional forces between the disc and a read/write head. A thin layer of lubricant, applied to the surface of the protective overcoat, is used to enhance the tribological performance of the head-disc interface by reducing friction and wear of the protective overcoat.

The reliability and tribological performance of a head-disc interface generally is monitored in terms of dynamic and/or static coefficients of friction or stiction values the head experiences during start-stop cycles. Dynamic stiction values can be measured using a standard drag test in which the drag produced by contact of a read/write head with a disc is determined at a constant spin rate, for example, 1 rotation per minute (rpm). Static stiction values can be measured using a standard contact start-stop (CSS) test in which the peak level of friction is measured as the disc starts rotating from zero to a selected revolution rate, for example, 5,400 rpm. After the peak friction is measured, the disc is brought to rest, and the start-stop process is repeated for a selected number of start-stop cycles. The tribological integrity and durability of a head-disc interface is often summarized by the number of CSS cycles before failure of the media as measured by unacceptably high friction values. An unacceptably high value of friction is an indicator of imminent head-disk failure or “head crash”.

Among the many lubricants available, liquid perfluoropolyethers (PFPEs) are the most utilized for forming topcoat lubricants on magnetic recording media. PFPEs are used because they possess certain desirable attributes for disc drive applications. For example, PFPEs are chemically inert, exhibit low vapor pressure, low surface tension, and high thermal stability. To achieve adhesion of the lubricant to the magnetic media requires the inclusion of polar and reactive functional groups, particularly on the end of the lubricating compound. Conventional lubricant systems typically comprise a mixture of a perfluoropolyether, such as “Fombline® Z-DOL” (Z-dol) available from Solvay Solexis, and a catalytic blocking agent, such as the hexaphenoxy compound “X—1P” available from Dow Chemicals Co. The PFPE Z-dol has polar hydroxyl end-groups that provide increased adhesion of the lubricant to the disc while the catalytic blocking agent prevents catalytic decomposition of the PFPE during head-disc contact.

As storage densities increase, the distance between a flying head and the magnetic layer of the thin-film medium decreases. Decreasing the distance between the flying head and magnetic layer involves increasing the smoothness of the media surface as well as reducing the thicknesses of the intermediary lubricant topcoat layer and protective overcoat layer. While conventional lubricants having polar or functional end-groups exhibit adequate adhesion under certain conditions, these lubricants compromise the stability and durability of the lubricant topcoat at ultra-thin thicknesses below 15 angstroms (Å).

As lubricant layer thicknesses are reduced to below 15 Å, physical bonding between an ultra-thin film of lubricant and the protective overcoat becomes less stable. Chemical bonding between the lubricant and the protective overcoat becomes increasingly important for maintaining a stable and uniform ultra-thin lubricant topcoat, particularly under increasingly demanding environmental conditions.

In view of the criticality of the lubricant topcoat in magnetic recording media, there continues to be a need to enhance the adhesion of ultra-thin lubricant films to the magnetic media while maintaining the desired tribological properties. In particular, there is a need for lubricants capable of achieving stronger bonding and preferably chemical bonding to the magnetic medium. There is also a need for lubricants for use as topcoats in the manufacture of magnetic recording media capable of achieving stronger bonding, and preferably chemical bonding, to the underlying protective overcoat and maintaining a uniform and stable film at ultra-thin film thicknesses.

### SUMMARY OF THE INVENTION

The invention generally provides a lubricant composition comprising a perfluoropolyether chain having one or more epoxide rings, a method of manufacturing a magnetic storage medium, and a magnetic storage medium. In one embodiment, one or more epoxide rings may be included in an end group on the perfluoropolyether chain. In another embodiment the end-group comprising one or more epoxide rings may be located at both ends of the perfluoropolyether chain. In another embodiment, a method of manufacturing a magnetic storage medium comprising applying a lubricant topcoat to a magnetic storage medium wherein the lubricant topcoat comprises a perfluoropolyether having one or more end-groups comprising an epoxide ring. Still another embodiment comprises a magnetic storage medium including a substrate, a magnetic layer formed over the substrate, a protective overcoat formed over the magnetic layer, and a lubricant topcoat formed over the protective overcoat wherein the lubricant topcoat comprises a perfluoropolyether having one or more end-groups comprising an epoxide ring.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically depicts a cross-sectional view of a portion of a magnetic recording medium structure to which the present invention is applicable.

FIG. 2 is a graph illustrating the bonding achieved with the lubricant of the present invention before and after UV irradiation.

FIG. 3 is a high resolution ESCA/XPS spectrum of the lubricant of the present invention before and after UV irradiation.

FIG. 4 comparatively depicts the CSS failure rate of the lubricant of the present invention to those of conventional lubricants.

### DETAILED DESCRIPTION OF THE PREFERRED EMBODIMENT

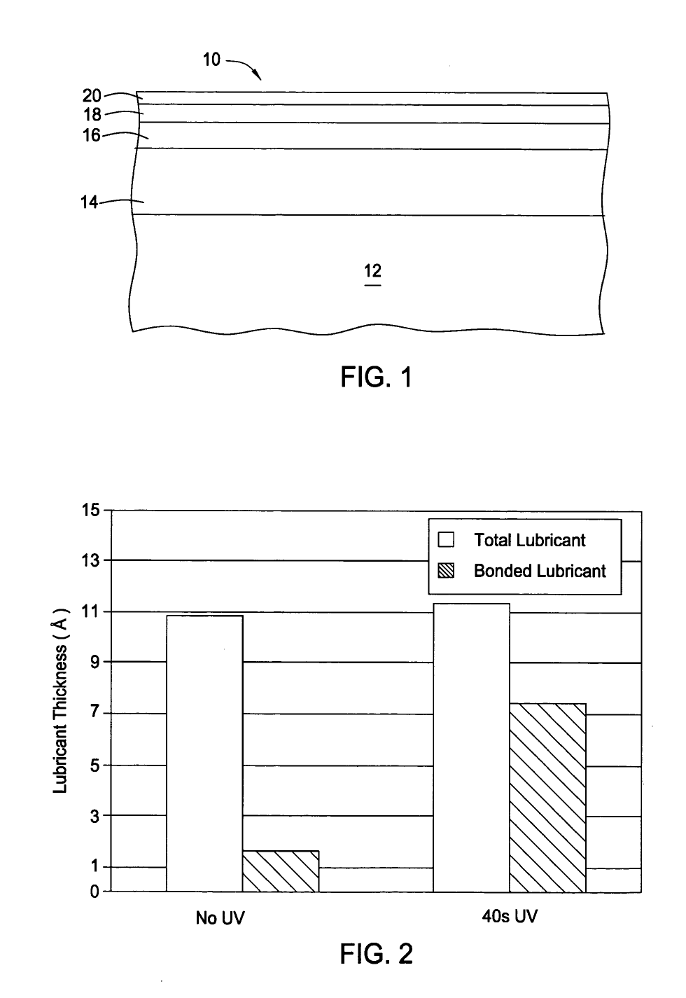

FIG. 1 schematically depicts a cross-sectional view of a portion of a magnetic recording medium structure to which the present invention is applicable. Typically, a thin-film medium or disc 10 includes a rigid disk-like substrate 12 and various thin-film layers, including a crystalline underlayer 14, a magnetic thin-film layer 16, a protective overcoat 18, and a lubricant topcoat 20. The substrate 12 can be, for example, a textured substrate such as a conventional surface-coated, textured aluminum substrate, or a textured glass or ceramic substrate. The crystalline underlayer 14 can include, for example, a sputtered chromium (Cr) underlayer 14 having a thickness in the range of about 300 to about 3,000 angstroms (Å). Alternatively, the underlayer 14 can be formed of a chromium-based alloy, such as CrGd, CrV, CrTi or CrSi. The magnetic film layer 16 can be, for example, a cobalt-based alloy, in other words, an alloy containing at least 50% cobalt, which is formed on the underlayer 14 by sputtering or other known techniques. Exemplary thin-film alloys include binary and ternary alloys such as Co/Cr, Co/Ni, Co/Cr/Ta, Co/Ni/Pt and Co/Cr/Ni, and quaternary and five-element alloys such as Co/Ni/Cr/Pt, Co/Cr/Ta/Pt, Co/Cr/Ta/Pt/B and Co/Cr/Ni/Pt/B. A wear-resistant, protective overcoat 18, typically a carbon overcoat, is sputtered over the magnetic recording layer 16. Exemplary overcoat materials 18 include amorphous carbon (α—C:H), amorphous carbon-nitride (α—C:N and α—C:H:N). Other materials also can be used as the protective overcoat 18. In some implementations, the carbon overcoat 18 has a thickness of about 20 Å to about 50 Å. The topical lubricant layer 20 is typically a thin layer of a perfluoropolyether (PFPE) oil. A lubricant compound according to embodiments of the invention makes up the lubricant topcoat 20 in FIG. 1.

One embodiment of the lubricant compound (Ep-PFPE) comprises a perfluoropolyether chain having an end-group comprising at least one epoxide ring, the general structure having the formula:
(1) A-PFPE
in which A represents the end-group comprising at least one epoxide ring and PFPE represents the perfluoropolyether chain. Another embodiment of the Ep-PFPE lubricant compound comprises a perfluoropolyether chain having an end-group comprising at least one epoxide ring at both ends of the perfluoropolyether chain, the general structure having the formula:
(2) A-PFPE-A
in which A represents the end-group comprising at least one epoxide ring and PFPE represents the perfluoropolyether chain.

In regards to formula (1) and formula (2), the epoxide ring has the following general structure: 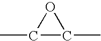
Although many sources of the three-membered epoxide ring structure exist, a very common source is epichlorohydrin.

Additionally, in regards to formula (1) and formula (2) the PFPE chain may include, but is not limited to, the following structures:
—(CF₂—CF₂—O)ₚ—(CF₂—O)_{q}—;
—(CF(CF₃)—CF₂—O)ₚ—(CF₂—O)_{q}—;
—(CF₂—CF₂—CF₂—O)ₚ—; and
—(CF(CF₃)—CF₂—O)ₚ—;
   wherein p and q are integers. The PFPE chains may be partially fluorinated and the copolymer PFPE chains are typically random. Suitable PFPE lubricants include, but are not limited to, PFPEs having functionalized end-groups, such as Fomblin® Z-dol having —CH₂OH end-groups, Fombline® Z-dol TX having —CH₂(O—CH₂—CH₂)ₙOH end-groups wherein n is an integer, and Fomblin® Z Tetraol having —CH₂OCH₂CH(OH)CH₂OH end-groups, these functional PFPEs are available from Solvay Solexis.

A preferred embodiment of the Ep-PFPE lubricant compound has the general structure:
X—R—(CF₂—CF₂—O)ₚ—(CF₂—O)_{q}—R—Y
in which X represents an epoxide ring; Y represents a hydroxyl, alkyl, fluoroalkyl, or perfluoroalkyl; R represents a fluoroalkyl, perfluoroalkyl, alkyl, fluoroalkoxy, perfluoroalkoxy, or alkoxy; and q and p may be the same or different and may be between 1 and 500. Another preferred embodiment of the Ep-PFPE lubricant compound has the general structure:
X—R—(CF₂—CF₂—O)ₚ—(CF₂—O)_{q}—R—X
in which X represents an epoxide ring; R represents a fluoroalkyl, perfluoroalkyl, alkyl, fluoroalkoxy, perfluoroalkoxy, or alkoxy; and q and p may be the same or different and may be between 1 and 500. Other embodiments of the present lubricant include partially fluorinated PFPE chains and can be linear or branched.

One example of the synthesis process for preparing Ep-PFPE comprises the following general equation: 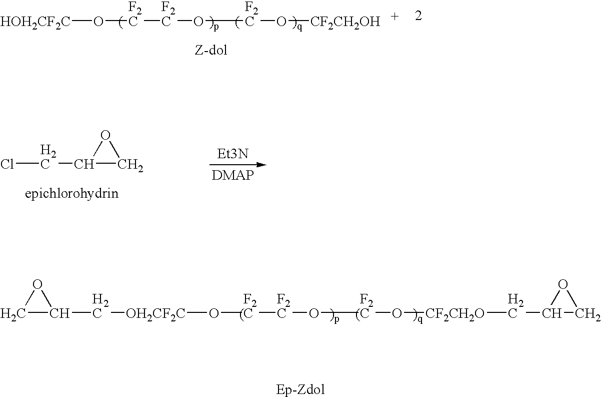
The process comprises dissolving fractionated Z-dol, available from Solvay Solexis, in a hydrofluorocarbon “Vertrel® XF” available from DuPont in a ratio of about 1 gram Z-dol to about 10 ml Vertrel® XF. The molecular weight of Z-dol may be a molecular weight in the range of about 2000-6000 Daltons. For achieving a high yield of Ep-PFPE, epichlorohydrin is added in excess in a ratio of about 3 to 4 grams epichlorohydrin to about 1 gram Z-dol. The Vertrel® XF diluted Z-dol and epichlorohydrin are combined in a flask containing 4-dimethylaminopyridine (DMAP) catalyst. For this reaction, the amount of DMAP catalyst is about 1% by weight of Z-dol. Triethylamine, a base, is dropwise added to the solution as an acid acceptor for the HCl that is generated during reaction. It is to be noted that there are many catalysts that could be used in lieu of DMAP and there are many bases that could be used in lieu of triethylamine. The mixture is constantly stirred with a mechanical stirrer and the flask is water-bath cooled to control the temperature. There is also a condensation/reflux line connected to the flask primarily for maintaining the volatile Vertrel® XF in solution. The reaction is allowed to go to completion overnight or for about 8-12 hours.

After reaction, the Ep-PFPE is extracted and purified. First, the amine in the solution is neutralized with an acid, such as HCl. The solution is washed with water to remove excess epichlorohydrin and residual triethylamine. The remaining solution of Ep-PFPE in excess Vertrel® XF, is distilled to remove the Vertrel® XF. The remaining Ep-PFPE is then purified using liquid chromatography followed by a supercritical fluid extraction purification step. A clear liquid product of Ep-PFPE was identified by a FTIR infrared spectrometer.

Many other synthesis processes for preparing Ep-PFPE are also possible. In addition, synthesis of Ep-PFPE is not limited to using Z-dol and epichlorohydrin as the reactants. Synthesis of Ep-PFPE may be accomplished by combining other functional PFPEs, having one or more functionalized end-groups, with an epoxy compound. Other analytical tools, including gel permeation chromatography (GPC) and thermogravimetric analysis (TGA), may be used for identifying the Ep-PFPE product.

The present Ep-PFPE lubricant compounds, whether of formula (1) or formula (2) preferably have an average molecular weight of between about 2,000 Daltons and about 6,000 Daltons. The Ep-PFPE is preferably fractionated. Fractionation can be achieved by distillation under vacuum, supercritical fluid fractionation, chromatography, e.g., GPC, or other molecular weight separation techniques.

The Ep-PFPE lubricant may be applied over magnetic media by any technique known in the art, such as dip, vapor, spray, solvent, solvent-free, vacuum, and non-vacuum processes. The Ep-PFPE lubricant may be applied as one layer or as multiple layers. To provide desirable lubricating properties, the Ep-PFPE lubricant is preferably applied to a thickness between about 8 Å and about 30 Å. Ep-PFPE lubricant layer thicknesses of less than 8 Å and greater than 30 Å may also be used. After application to the media, the Ep-PFPE lubricant is only weakly bonded to the carbon overcoat primarily due to the weak interaction between the epoxide ring and the carbon overcoat. A post-treatment of the lubricant topcoat is performed using ultraviolet (UV) light irradiation to increase the bonding of the Ep-PFPE lubricant molecules to the protective overcoat. Other energy sources may be used such as electron beam, ion beam radiation, infrared (IR), hydrogen/proton beam (H-beam), plasma, heat, or other treatments known in the art.

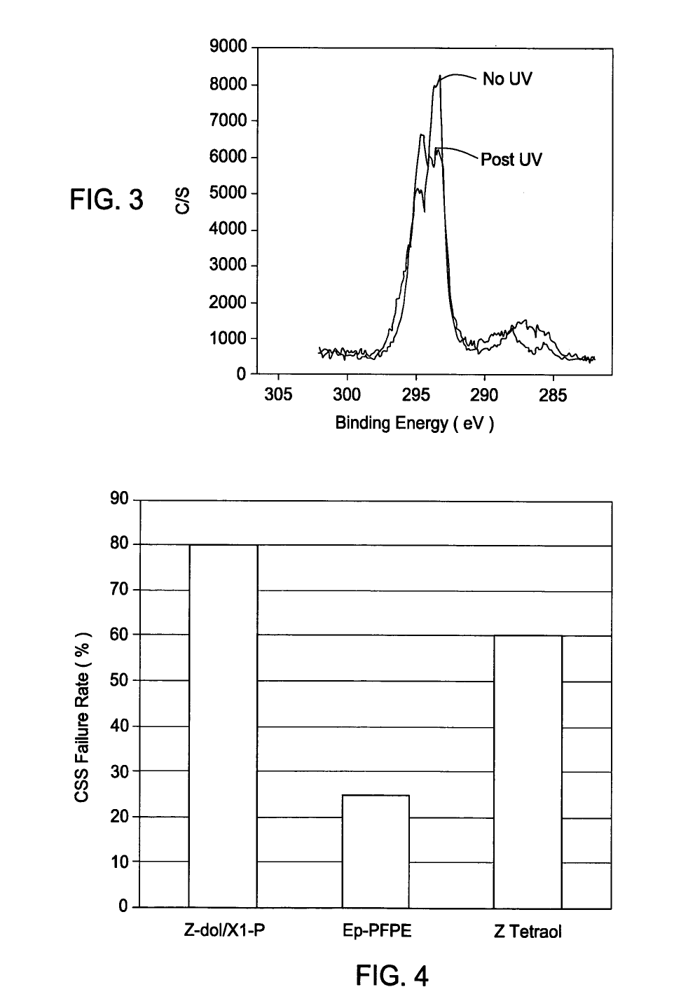

FIGS. 2 and 3 illustrate the bonding achieved with the Ep-PFPE lubricant of the present invention before and after UV irradiation. Samples of carbon overcoated magnetic media were dip coated with Ep-PFPE lubricant and exposed to 40 seconds of UV radiation. The total thickness of the lubricant layer remained essentially unchanged at about 11 Å, however the amount of bonded lubricant substantially increased after exposure to UV. The ESCA plots in FIG. 3 show that after UV treatment there is more oxygen bonded on the surface of the carbon overcoat. In order to increase the resolution, the samples were exposed to 2 minutes of UV radiation. The post-UV treatment curve shows an increase in the amount of C—O and C═O bonding. Not wishing to be bound by theory, it is believed that during UV irradiation, the epoxide ring structure breaks and the oxygen atom is free to chemically bond to the carbon overcoat.

As illustrated in the following examples, the lubricant of the present invention provides improved tribological performance over conventional lubricants, such as Z-dol, at ultra-thin film thicknesses. The present lubricant compounds provide good lubrication properties, while maintaining a uniform and stable film at ultra-thin film thicknesses.

### EXAMPLES

The following tests demonstrate the capabilities of the present invention and such examples are offered by way of illustration and not by way of limitation.

### Example 1

Contact start-stop (CSS) tests were performed on samples comprising a disc having a carbon overcoat with various fractionated lubricants formed thereover. A first sample comprised discs lubricated with a mixture of fractionated Z-dol and X1—P additive. A second sample comprised discs lubricated with fractionated Ep-PFPE having an epoxide end-group at both ends of the perfluoropolyether chain, and a third comparative sample comprised discs lubricated with fractionated Z Tetraol. Each of the lubricants had a molecular weight (Mw) in the range of about 2000 Daltons to 4000 Daltons and a polydispersity (Mw/Mn) of about 1 to 1.04. All the samples had lubricant topcoat thicknesses of about 10 Å and were UV irradiated for 40 seconds.

Contact start-stop tests were performed in a conventional spin stand using 20,000 start/stop cycles under stressful conditions of high relative humidity of 80% and temperature of 300 C. The CSS cycles also included occasional back rotation. The discs were spun up to a speed of 7,200 rpm. FIG. 4 shows the CSS failure rate of the three samples. The present invention of Ep-PFPE demonstrated excellent CSS performance and showed substantially improved CSS performance as compared to Z-dol/X1—P and Z Tetraol.

### Example 2

Potentiostatic corrosion tests were also performed on samples comprising a substrate having a carbon overcoat with various lubricants formed thereover. A first sample comprised a disc lubricated with a mixture of fractionated Z-dol and X1—P. A second sample comprised a disc lubricated with fractionated Ep-PFPE having an epoxide end-group at both ends of the perfluoropolyether chain, and a third comparative sample comprised a disc lubricated with fractionated Z Tetraol. All the samples were UV irradiated for 40 seconds. Each sample was immersed into a sodium chloride solution and was biased at a 900 mV potential for 10 minutes. The total amount of charge (“total corrosion charge”) passing through each system over this 10 minute period of time was measured and calculated. The total corrosion charge of the Ep-PFPE sample was satisfactory and comparable to the Z Tetraol sample. Both the Ep-PFPE sample and Z Tetraol sample showed better potentiostatic corrosion resistance than the Z-dol/X1—P sample. Not wishing to be bound by theory, it is believed that the potentiostatic corrosion resistance data shows that Ep-PFPE and Z Tetraol are more resistant to decomposition as compared to the Z-dol/X1—P.

While the foregoing is directed to embodiments of the present invention, other and further embodiments of the invention may be devised without departing from the basic scope thereof, and the scope thereof is determined by the claims that follow.

1. A lubricant composition, comprising:
a perfluoropolyether chain; and
at least one epoxide ring.

2. The lubricant composition of claim 1, having the formula A-PFPE wherein A is an end-group comprising the at least one epoxide ring, and PFPE is a perfluoropolyether chain.

3. The lubricant composition of claim 1, having the formula A-PFPE-A wherein A is an end-group comprising the at least one epoxide ring, and PFPE is a perfluoropolyether chain.

4. The lubricant composition according to claim 2, having the formula:
X—R—(CF₂—CF₂—O)ₚ—(CF₂—O)_{q}—R—Y
wherein:
X is an epoxide ring;
Y is an epoxide ring, hydroxyl, alkyl, fluoroalkyl, or perfluoroalkyl;
R is a fluoroalkyl, perfluoroalkyl, alkyl, fluoroalkoxy, perfluoroalkoxy, or alkoxy; and
p and q are integers between 0 and 500 wherein at least one of p and q is greater than 1.

5. The lubricant composition according to claim 4, wherein Y is an epoxide ring.

6. The lubricant composition according to claim 4, wherein Y is a hydroxyl group.

7. The lubricant composition according to claim 2, having the formula R—(CF₂—CF₂—O)ₚ—(CF₂—O)_{q}—R—X wherein X is an epoxide ring, R is a fluoroalkyl, perfluoroalkyl, alkyl, fluoroalkoxy, perfluoroalkoxy, or alkoxy, and p and q are integers between 0 and 500 wherein at least one of p and q is greater than 1.

8. The lubricant composition according to claim 5, having the formula: 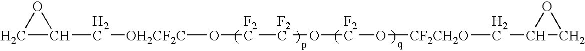
wherein p and q are integers between 1 and 500.

9. The lubricant composition of claim 1, wherein the lubricant composition comprises a molecular weight distribution of about 1.

10. A method of manufacturing a magnetic recording medium, comprising:
forming a magnetic layer over a substrate; and
applying a lubricant topcoat over the magnetic layer, the lubricant topcoat comprising perfluoropolyether having one or more end-groups comprising at least one epoxide ring.

11. The method according to claim 10, wherein the lubricant is prepared by reacting a perfluoropolyether chain having one or more functionalized end-groups with an epoxy compound.

12. The method according to claim 11, wherein the perfluoropolyether is fractionated prior to preparing the lubricant.

13. The method according to claim 10, further comprising forming a protective overcoat over the magnetic layer, wherein the lubricant topcoat is applied onto the protective overcoat.

14. The method according to claim 13, further comprises bonding at least a portion of the lubricant topcoat to the protective overcoat, the lubricant topcoat having both bonded lubricant and non-bonded lubricant.

15. The method according to claim 14, further comprises exposing the lubricant topcoat to an energy source to increase the relative amount of bonded lubricant.

16. The method according to claim 15, wherein exposing the lubricant topcoat to an energy source includes exposing the lubricant film to at least one of ultraviolet (UV) light irradiation, electron beam, hydrogen beam, and ion beam radiation.

17. A magnetic recording medium comprising:
a substrate;
a magnetic layer;
a protective overcoat formed over the magnetic layer; and
a lubricant topcoat formed over the protective overcoat, wherein the lubricant topcoat comprises a perfluoropolyether having one or more end-groups comprising at least one epoxide ring.

18. The magnetic recording medium of claim 17, wherein the protective overcoat is a carbon containing overcoat.

19. The magnetic recording medium of claim 17, wherein the lubricant topcoat is formed to a thickness between about 5 Å and about 30 Å.

20. The magnetic recording medium of claim 19, wherein the lubricant topcoat is more preferably formed to a thickness between about 8 Å and about 13 Å.

21. The magnetic recording medium of claim 17, wherein the lubricant topcoat comprises both bonded lubricant and non-bonded lubricant.

22. The magnetic recording medium of claim 21, wherein the lubricant topcoat comprises about 10% to about 100% bonded lubricant and about 90% to about 0% non-bonded lubricant.

23. The magnetic recording medium of claim 22, wherein the lubricant topcoat preferably comprises about 40% to about 90% bonded lubricant and about 60% to about 10% non-bonded lubricant.

24. The magnetic recording medium of claim 23, wherein the lubricant topcoat more preferably comprises about 50% to about 80% bonded lubricant and about 50% to about 20% non-bonded lubricant.

25. The magnetic recording medium of claim 17, further comprising:
an underlayer formed over the substrate; and
the magnetic layer formed over the underlayer.

26. The magnetic recording medium of claim 17, wherein the average molecular weight of the perfluoropolyether is between about 2,000 and 6,000 Daltons.

27. The magnetic recording medium of claim 17, wherein the lubricant topcoat comprises a single molecular weight perfluoropolyether.

28. The magnetic recording medium of claim 17, wherein the lubricant topcoat has the formula:
X—R—(CF₂—CF₂—O)ₚ—(CF₂—O)_{q}—R—Y
wherein:
X is an epoxide ring;
Y is an epoxide ring, hydroxyl, alkyl, fluoroalkyl, or perfluoroalkyl;
R is a fluoroalkyl, perfluoroalkyl, alkyl, fluoroalkoxy, perfluoroalkoxy, or alkoxy; and
p and q are integers between 0 and 500 wherein at least one of p and q is greater than 1.

29. The method according to claim 17, wherein the lubricant topcoat has the formula: 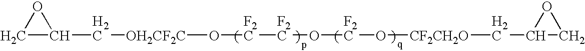
wherein p and q are integers between 1 and 500.
